(19) United States
(12) Patent Application Publication
(10) Pub. No.: US 2025/0137657 A1
(43) Pub. Date: May 1, 2025

(54) HEATING COOKER

(71) Applicant: SHARP KABUSHIKI KAISHA, Osaka (JP)

(72) Inventors: SHINJI ASAMI, Osaka (JP); Mariko Yachi, Osaka (JP)

(21) Appl. No.: 18/929,888

(22) Filed: Oct. 29, 2024

(30) Foreign Application Priority Data
Oct. 31, 2023 (JP) 2023-186344

(51) Int. Cl. F24C 15/02; A47J 37/04; F24C 1/14

(52) U.S. Cl. CPC F24C 15/02; A47J 37/041; F24C 1/14

(57) ABSTRACT

A heating cooker includes a heating cooking compartment, a door, a heater unit, a turntable, a drive unit, a fan, and a guide unit. The heating cooking compartment has an opening. The door opens and closes the opening. The heater unit is disposed below the heating cooking compartment. The turntable is disposed inside the heating cooking compartment and allows a heating-target object to be placed on the turntable. The drive unit is disposed below the heating cooking compartment and drives the turntable. The fan generates an air flow. The guide unit guides an air flow. The drive unit is disposed closer to the door than the heater unit. The guide unit guides the air flow to the drive unit.

### BACKGROUND OF THE INVENTION

### 1. Technical Field

The present disclosure relates to a heating cooker. This application claims the benefit of priority to Japanese Patent Application Number 2023-186344 filed on Oct. 31, 2023. The entire contents of the above-identified application are hereby incorporated by reference.

### 2. Description of the Related Art

JP H8-195280 A discloses a heating cooker. The heating cooker disclosed in JP H8-195280 A includes a turntable, a turntable motor, a lower heater, and a cooling fan. According to the heating cooker disclosed in JP H8-195280 A, the turntable motor is positioned on a windward side of the lower heater, thereby decreasing a heat load from the lower heater on the turntable motor.

### SUMMARY OF THE INVENTION

However, in the heating cooker disclosed in JP H8-195280 A, the turntable motor is positioned on the windward side of the lower heater. In other words, it is not possible for the turntable motor to be disposed on a leeward side of the lower heater.

In view of the above problem, an object of the present disclosure is to provide a heating cooker capable of efficiently cooling a drive unit that drives a turntable even when the drive unit is disposed on a leeward side of a heater unit.

According to one aspect of the present disclosure, a heating cooker includes a heating cooking compartment, a door, a heater unit, a turntable, a drive unit, a fan, and a guide unit. The heating cooking compartment has an opening. The door opens and closes the opening. The heater unit is disposed below the heating cooking compartment. The turntable is disposed inside the heating cooking compartment and allows a heating-target object to be placed on the turntable. The drive unit is disposed below the heating cooking compartment and drives the turntable. The fan generates an air flow. The guide unit guides the air flow. The drive unit is disposed closer to the door than the heater unit. The guide unit guides the air flow to the drive unit.

According to the heating cooker of the present disclosure, even when the drive unit that drives the turntable is disposed on a leeward side of the heater unit, the drive unit can be efficiently cooled.

### BRIEF DESCRIPTION OF THE DRAWINGS

FIG. 1 is a perspective view illustrating a heating cooker according to an embodiment of the present disclosure;

FIG. 2 is a perspective view illustrating the heating cooker in a state where a housing is removed according to the embodiment;

FIG. 3 is a perspective view illustrating the heating cooker in a state where the housing is removed according to the embodiment;

FIG. 4 is a perspective view illustrating a door according to the embodiment;

FIG. 5 is a view illustrating a schematic cross section of the heating cooker according to the embodiment;

FIG. 6 is a view illustrating an enlarged cross section of the heating cooker according to the embodiment;

FIG. 7 is a view illustrating a schematic cross section of the heating cooker according to the embodiment;

FIG. 8 is a perspective view illustrating the heating cooker in a state where the housing is removed according to the embodiment;

FIG. 9 is a perspective view illustrating the heating cooker in a state where the housing is removed according to the embodiment; and

FIG. 10 is a block diagram illustrating a configuration of the heating cooker according to the embodiment.

### DETAILED DESCRIPTION

Hereinafter, with reference to the drawings, an embodiment of a heating cooker according to the present disclosure will be described. Note that, in the drawings, the same or corresponding portions are denoted by the same reference numerals, and descriptions thereof will not be repeated.

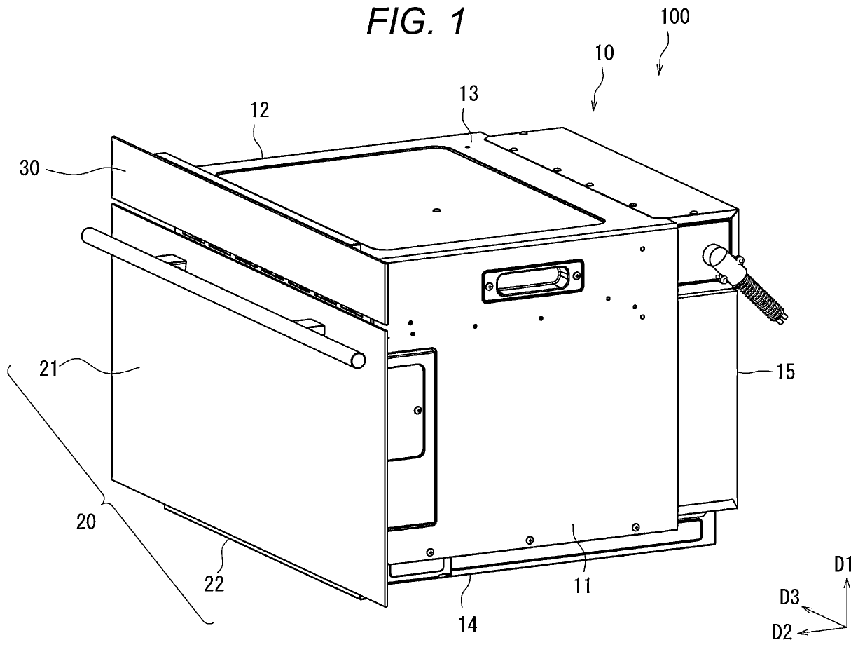

With reference to FIG. 1, a heating cooker 100 according to the embodiment will be described. FIG. 1 is a perspective view illustrating the heating cooker 100. In addition, FIG. 1 illustrates the external appearance of the heating cooker 100 when viewed diagonally from the upper right front. As illustrated in FIG. 1, the heating cooker 100 heats and cooks a heating-target object. The heating-target object is, for example, a food item. The heating cooker 100 includes a housing 10, a door 20, and an operation panel 30.

The operation panel 30 is a substantially rectangular plate-shaped member. The operation panel 30 receives an operation from a user. The operation includes, for example, a cooking method for heating and cooking a heating-target object. Specifically, the operation panel 30 includes a display unit. The display unit displays various items of information. Specifically, the display unit includes a liquid crystal panel.

In the embodiment, a side of the heating cooker 100 on which the operation panel 30 is disposed is defined as a front side of the heating cooker 100, and a side (back surface side) opposite to the front side is defined as a rear side of the heating cooker 100. In addition, when the heating cooker 100 is viewed from the front side, a right side is defined as a right side of the heating cooker 100, and a side opposite to the right side is defined as a left side of the heating cooker 100. In addition, in a direction orthogonal to a front-rear direction and a left-right direction of the heating cooker 100, a side on which the operation panel 30 is disposed is defined as an upper side of the heating cooker 100, and a side (bottom side) opposite to the upper side is defined as a lower side of the heating cooker 100. Note that, these directions and sides are not intended to limit directions and sides when the heating cooker 100 of the present disclosure is used. In the embodiment, a first direction D1 is an upward direction. A second direction D2 is a forward direction. A third direction D3 is a left direction.

The housing 10 is a box-shaped member. Specifically, the housing 10 has a right outer wall 11, a left outer wall 12, an upper outer wall 13, a lower outer wall 14, and a rear outer wall 15. The rear outer wall 15 intersects the second direction D2. The right outer wall 11 and the left outer wall 12 face each other in the third direction D3. The upper outer wall 13 and the lower outer wall 14 face each other in the first direction D1.

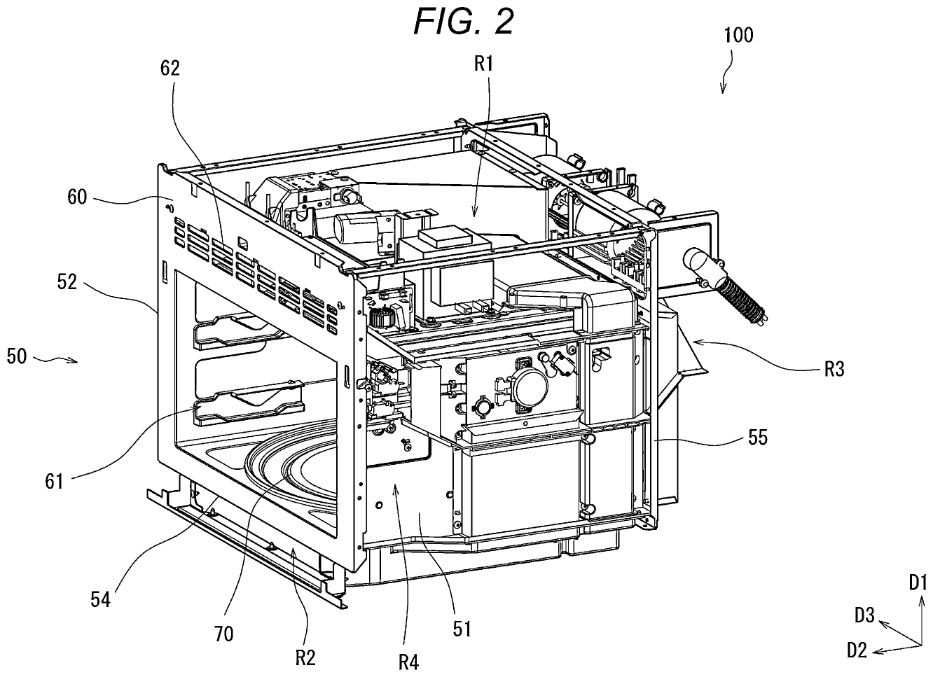

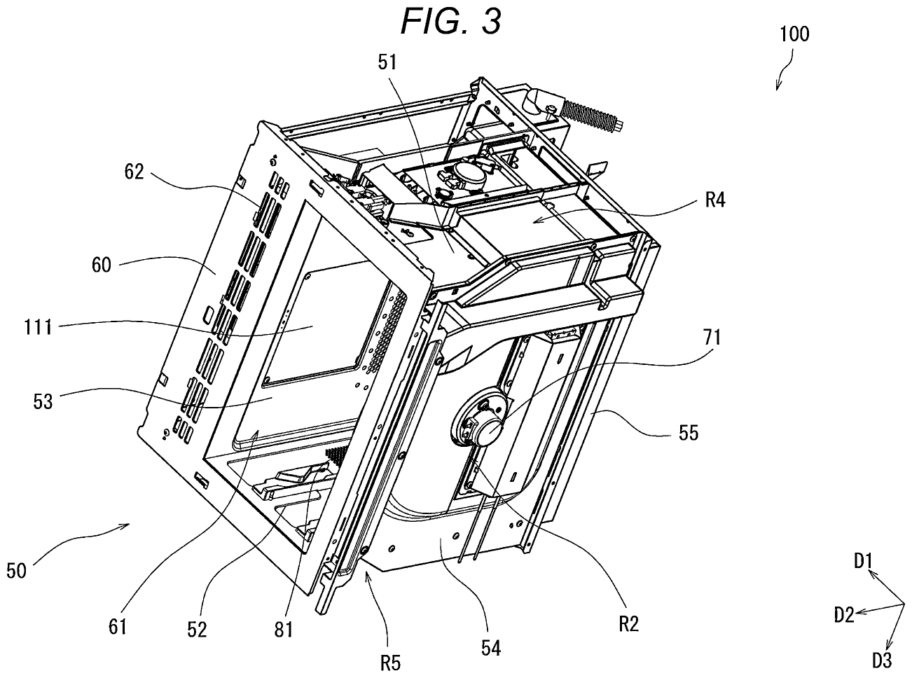

Continuing, a heating cooking compartment 50 will be described with reference to FIGS. 1 to 3. FIGS. 2 and 3 are perspective views illustrating the heating cooker 100 from which the housing 10 has been removed. FIG. 2 illustrates the external appearance of the heating cooker 100 when viewed diagonally from the upper right front. FIG. 3 illustrates the external appearance of the heating cooker 100 when viewed diagonally from the lower right front. As illustrated in FIGS. 2 and 3, the heating cooker 100 further includes the heating cooking compartment 50, a front wall 60, a turntable 70, and a drive unit 71.

The heating cooking compartment 50 is accommodated in the housing 10. The heating cooking compartment 50 allows a heating-target object to be accommodated therein. The heating cooking compartment 50 has, for example, a substantially rectangular parallelepiped shape. Specifically, the heating cooking compartment 50 has a right wall 51, a left wall 52, an upper wall 53, a lower wall 54, and a rear wall 55. The rear wall 55 intersects the second direction D2. The right wall 51 and the left wall 52 face each other in the third direction D3. The upper wall 53 and the lower wall 54 face each other in the first direction D1. Examples of a material of each of the right wall 51, the left wall 52, the upper wall 53, the lower wall 54, and the rear wall 55 are metals.

The turntable 70 is a dish-shaped member. The turntable 70 is disposed inside the heating cooking compartment 50. The heating-target object is placed on the turntable 70. To be specific, the turntable 70 is rotatable about a rotation axis in the first direction D1.

The drive unit 71 is disposed below the heating cooking compartment 50. Specifically, the drive unit 71 is disposed on the lower wall 54 of the heating cooking compartment 50. The drive unit 71 drives the turntable 70. The drive unit 71 includes, for example, a motor.

The heating cooker 100 further includes a first space R1, a second space R2, a third space R3, a fourth space R4, and a fifth space R5. The first space R1 is disposed between the upper outer wall 13 and the upper wall 53. The second space R2 is disposed between the lower outer wall 14 and the lower wall 54. The third space R3 is disposed between the rear outer wall 15 and the rear wall 55. The fourth space R4 is disposed between the right outer wall 11 and the right wall 51. The fifth space R5 is disposed between the left outer wall 12 and the left wall 52.

The front wall 60 is a plate-shaped member having a quadrangular ring shape. The front wall 60 faces the rear wall 55. In addition, the front wall 60 faces the rear outer wall 15. The front wall 60 includes an opening 61 and through-hole portions 62. The opening 61 allows an inside and an outside of the heating cooking compartment 50 to communicate with each other.

The plurality of through-hole portions 62 are positioned above the opening 61. Each of the plurality of through-hole portions 62 allows an inside and an outside of the first space R1 to communicate with each other. The plurality of through-hole portions 62 form eight columns. In each of the eight columns of the through-hole portions 62, three through-holes are arranged in a column in an up-down direction.

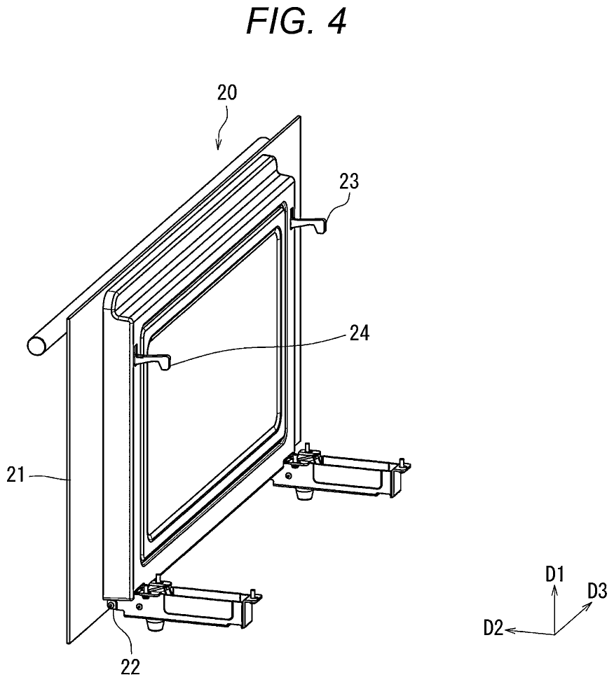

Continuing, the door 20 will be described with reference to FIGS. 1 to 4. FIG. 4 is a perspective view illustrating the door 20. As illustrated in FIGS. 1 to 4, the door 20 includes a substantially rectangular plate-shaped member 21 and a rotary shaft unit 22.

The rotary shaft unit 22 is positioned below the plate-shaped member 21. The plate-shaped member 21 opens and closes the opening 61. Specifically, the plate-shaped member 21 rotates about a rotation axis in the third direction D3. The plate-shaped member 21 opens the opening 61 in a state of being orthogonal to the first direction D1. On the other hand, the plate-shaped member 21 closes the opening 61 in a state of being orthogonal to the second direction D2.

To be specific, the door 20 includes a first connection member 23 and a second connection member 24. Both the first connection member 23 and the second connection member 24 connect the heating cooking compartment 50 and the door 20 when the door 20 is positioned at a closed position.

The first connection member 23 and the second connection member 24 are attached to the plate-shaped member 21. The first connection member 23 and the second connection member 24 face each other in the left-right direction. The first connection member 23 is attached to a left edge portion of a rear surface of the plate-shaped member 21. The second connection member 24 is attached to a right edge portion of the rear surface of the plate-shaped member 21.

For example, each of the first connection member 23 and the second connection member 24 has a hook member. The hook member is a plate-shaped member having a longitudinal direction thereof in the front-rear direction. The hook member includes a claw portion and a rotation pin portion. The rotation pin portion is positioned at one end portion of the hook member. The rotation pin portion rotates about a rotation axis extending in the third direction D3. On the other hand, the claw portion has a projecting portion projecting downward. The claw portion is positioned at the other end portion of the hook member. As a result, the claw portion is rotatable around the rotation pin portion.

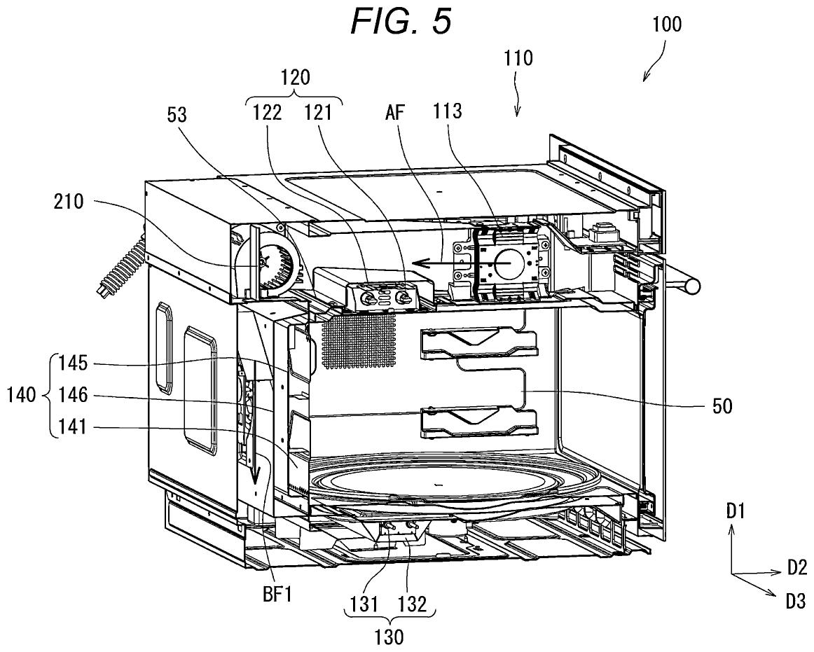

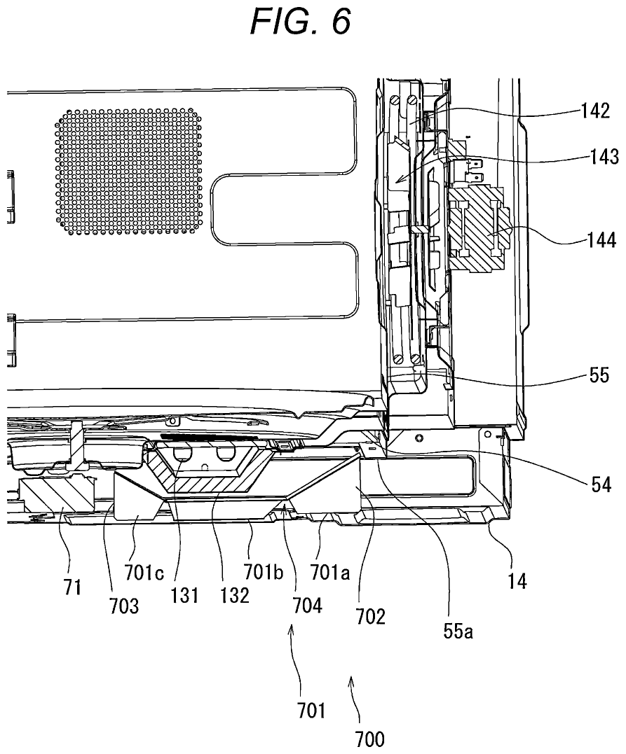

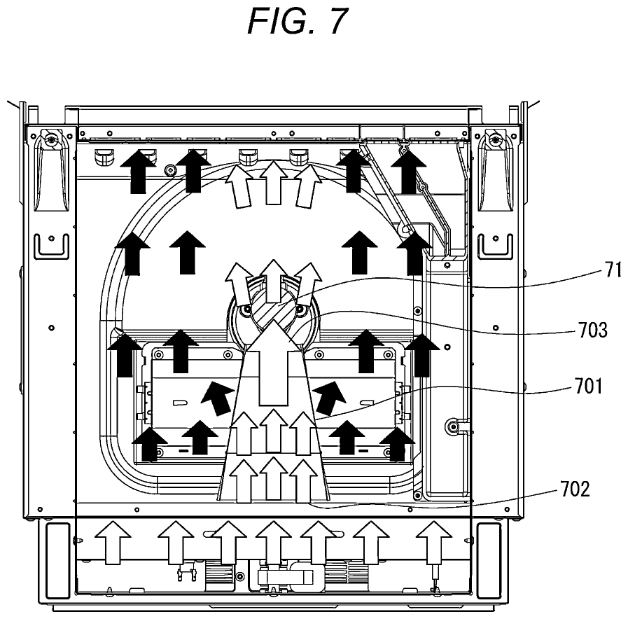

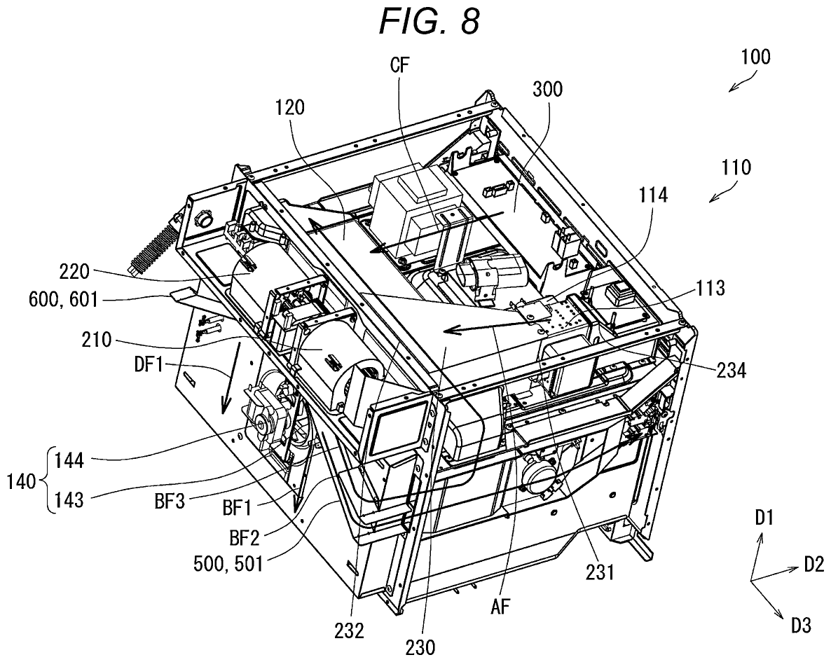

Next, the heating cooker 100 will be further described with reference to FIGS. 5 to 8. FIGS. 5 and 6 are views illustrating schematic cross sections of the heating cooker 100. To be specific, FIG. 5 is a cross-sectional view illustrating the heating cooker 100 cut along a plane orthogonal to the third direction D3. FIG. 6 is an enlarged cross-sectional view illustrating the heating cooker 100 cut along a plane orthogonal to the third direction D3. In addition, FIG. 7 is a cross-sectional view illustrating the heating cooker 100 cut along a plane orthogonal to the first direction D1. Further, FIG. 8 is a perspective view illustrating the heating cooker 100. To be specific, FIG. 8 illustrates the external appearance of the heating cooker 100 when viewed diagonally from the upper left rear.

As illustrated in FIGS. 5 to 8, the heating cooker 100 includes a microwave supply unit 110, a first heater unit 120, a second heater unit 130, and an air blower 140. The second heater unit 130 is an example of a “heater unit”. Each of the microwave supply unit 110, the first heater unit 120, the second heater unit 130, and the air blower 140 heats the heating-target object.

First, the microwave supply unit 110 will be described. The microwave supply unit 110 supplies microwaves into the heating cooking compartment 50.

The microwave supply unit 110 is disposed on the upper wall 53 of the heating cooking compartment 50. Specifically, the microwave supply unit 110 is positioned above the heating cooking compartment 50 with the upper wall 53 interposed therebetween. The microwave supply unit 110 includes a partition member 111, a radiation chamber, a magnetron 113, and a waveguide 114.

The magnetron 113 is disposed closer to the front wall 60 than the first heater unit 120. The magnetron 113 generates microwaves. The waveguide 114 propagates microwaves generated by the magnetron to the radiation chamber.

The partition member 111 is disposed between the radiation chamber and the upper wall 53 of the heating cooking compartment 50. Examples of a material of the partition member 111 are non-metals, and include a ceramic or mica. As a result, since the material of the partition member 111 contains a ceramic or mica, the partition member 111 transmits microwaves. On the other hand, materials of the radiation chamber and the waveguide 114 include metals.

Next, the first heater unit 120 will be described. The first heater unit 120 is disposed on the upper wall 53 of the heating cooking compartment 50. The first heater unit 120 is, for example, a carbon heater. As a result, since the temperature rises quickly, the heating-target object can be cooked in a short time. Specifically, the first heater unit 120 includes a first heater 121 and a thermal shield plate 122.

The first heater 121 is, for example, a carbon heater. The first heater 121 in the state of power application generates heat. The first heater 121 extends in the third direction D3.

The thermal shield plate 122 covers an upper side of the first heater 121. The thermal shield plate 122 covers an upper side, a front side, and a rear side of the first heater 121. The thermal shield plate 122 is made of a material including metal. The thermal shield plate 122 reflects heat toward the heating cooking compartment 50 and reduces heat transmission to the outside of the thermal shield plate 122.

Next, the second heater unit 130 will be described. The second heater unit 130 is disposed below the heating cooking compartment 50. Specifically, the second heater unit 130 is disposed on the lower wall 54 of the heating cooking compartment 50. Specifically, the second heater unit 130 and the first heater unit 120 face each other. In addition, the second heater unit 130 extends in the third direction D3. To be specific, the second heater unit 130 is disposed further apart from the front wall 60 than the drive unit 71 is. In other words, the drive unit 71 is disposed on the door 20 side from the second heater unit 130.

The second heater unit 130 includes a second heater 131 and a second heater case 132. The second heater 131 is, for example, a glass tube heater, and the resistance heating element is a nichrome wire. The second heater 131 in the state of power application generates heat. An output of the second heater 131 is lower than an output of the first heater 121. The second heater case 132 covers a lower side, a front side, and a rear side of the second heater 131. The second heater case 132 is made of a material including metal.

Next, the air blower 140 will be described. The air blower 140 is configured to supply hot air into the heating cooking compartment 50. The air blower 140 is disposed on the rear wall 55. Specifically, the air blower 140 is positioned behind the heating cooking compartment 50 with the rear wall 55 interposed therebetween.

Specifically, the air blower 140 includes an air blowing chamber 141, a third heater 142, a centrifugal fan 143, a drive unit 144, a partition member 145, and a heat shield plate 146. The air blowing chamber 141 is, for example, a box-shaped member made of metal. The centrifugal fan 143 has a plurality of blades.

The third heater 142 and the centrifugal fan 143 are accommodated in the air blowing chamber 141. The third heater 142 heats air inside the air blowing chamber 141 to generate hot air. Specifically, the third heater 142 has an annular shape when viewed from the front side toward the rear side. The third heater 142 is disposed along an outer circumference of the centrifugal fan 143.

The rear wall 55 has a suction hole portion and a blow-out hole portion. To be specific, the suction hole portion is, for example, a group of a plurality of punched holes. Similarly, the blow-out hole portion is also, for example, a group of a plurality of punched holes. A punched hole has, for example, a circular shape. A diameter of a punched hole of each of the suction hole portion and the blow-out hole portion is, for example, 3.4 mm in order to prevent microwaves from leaking.

Note that a height position of a lower end portion 55a of the rear wall 55 of the heating cooking compartment 50 is lower than a height position of the lower wall 54 of the heating cooking compartment 50.

The partition member 145 is, for example, a plate-shaped member made of metal. The partition member 145 has, for example, an oblong shape when viewed from the front side toward the rear side. The partition member 145 is disposed on substantially the entire surface of the rear wall 55. Specifically, the partition member 145 is positioned on the outward side from the rear wall 55.

The heat shield plate 146 is, for example, a plate-shaped member made of metal. The heat shield plate 146 is, for example, a plate-shaped member having a quadrangular ring shape when viewed from the front side toward the rear side. The heat shield plate 146 is positioned on the outward side from the partition member 145.

The drive unit 144 is positioned an outward side from the air blowing chamber 141. Specifically, the drive unit 144 is positioned on an outward side from the heat shield plate 146, and a shaft portion of the drive unit 144 penetrates the partition member 145 and the heat shield plate 146 and is connected to the centrifugal fan 143. The drive unit 144 drives the centrifugal fan 143. The drive unit 144 includes, for example, a motor.

The air blower 140 draws in hot air in the heating cooking compartment 50 through the suction hole portion, and blows hot air into the heating cooking compartment 50 through the blow-out hole portion. To be more specific, the air blower 140 draws in hot air from a central portion inside the heating cooking compartment 50 and blows the hot air to a peripheral border portion inside the heating cooking compartment 50. As a result, the entire inside of the heating cooking compartment 50 can be heated by driving the air blower 140.

As illustrated in FIGS. 5 to 8 again, the heating cooker 100 further includes a first fan 210, a first wind direction plate 500, and a guide unit 700. For example, the first fan 210 is a Sirocco fan. The first fan 210 is disposed on the upper wall 53 of the heating cooking compartment 50. In addition, the first fan 210 is disposed between the rear wall 55 of the heating cooking compartment 50 and the rear outer wall 15 of the housing 10. Specifically, the first fan 210 is disposed in a region in which the first space R1 and the third space R3 overlap each other.

To be specific, the first fan 210 is positioned at the same height as the plurality of through-hole portions 62 are. The first fan 210 generates an air flow between the upper wall 53 of the heating cooking compartment 50 and the upper outer wall 13 of the housing 10. The first fan 210 takes air outside the heating cooker 100 into the first space R1. In addition, the first fan 210 generates an air flow between the rear wall 55 of the heating cooking compartment 50 and the rear outer wall 15 of the housing 10. The first fan 210 discharges the air in the first space R1 into the third space R3.

The first wind direction plate 500 includes a first skew plate 501 and a second skew plate 503.

The first skew plate 501 is disposed on the heat shield plate 146. The first skew plate 501 is provided upright on the heat shield plate 146. The first skew plate 501 extends from below the first fan 210 toward the left wall 52.

The second skew plate 503 is disposed on the heat shield plate 146. The second skew plate 503 is provided upright on the heat shield plate 146. The second skew plate 503 is positioned on the upper side from the first skew plate 501. The second skew plate 503 extends from below the first fan 210 toward the left wall 52.

The guide unit 700 guides an air flow. The guide unit 700 guides the air flow from the first fan 210 to the drive unit 71. The guide unit 700 is disposed on the lower outer wall 14 of the housing 10. Specifically, in the left-right direction, the guide unit 700 is disposed at the center of the lower outer wall 14 of the housing 10. As a result, the lower outer wall 14 and the guide unit 700 guide the air flow to the drive unit 71.

The guide unit 700 is a groove-shaped object having a substantially U-shaped cross section. In addition, the shape of the guide unit 700 is trapezoidal in a plan view. Specifically, the guide unit 700 includes a groove-shaped body 701. The groove-shaped body 701 extends in the second direction D2. The groove-shaped body 701 faces the lower outer wall 14. The groove-shaped body 701 includes a rear groove-shaped body 701a, a middle groove-shaped body 701b, and a front groove-shaped body 701c. The rear groove-shaped body 701a is disposed behind the middle groove-shaped body 701b. The middle groove-shaped body 701b is disposed behind the front groove-shaped body 701c. A height of the middle groove-shaped body 701b is lower than a height of the front groove-shaped body 701c and a height of the rear groove-shaped body 701a.

In addition, the groove-shaped body 701 has a plurality of openings 704. Specifically, in the left-right direction, the plurality of openings 704 penetrate the groove-shaped body 701.

To be specific, the groove-shaped body 701 has a suction port 702 and a blow-out port 703. The suction port 702 is open in a direction opposite to the second direction D2. Specifically, the suction port 702 has a quadrangular shape. The blow-out port 703 is open in the second direction D2. Specifically, the blow-out port 703 has a quadrangular shape. The suction port 702 is larger in size than the blow-out port 703. In other words, a side surface of the groove-shaped body 701 is provided such that the blow-out port 703 is narrower than the suction port 702. The blow-out port 703 is close to the drive unit 71.

Here, a flow of air generated by driving of the first fan 210 will be described. When driven, the first fan 210 generates an intake air flow AF. The intake air flow AF passes through the plurality of through-hole portions 62 from the outside of the heating cooker 100, circulates in the first space R1 between the microwave supply unit 110 and the upper outer wall 13 in a direction opposite to the second direction D2, and flows toward the first heater unit 120. At this time, the intake air flow AF cools the magnetron 113 of the microwave supply unit 110. The intake air flow AF that has cooled the magnetron 113 circulates in the first space R1 between the first heater unit 120 and the upper outer wall 13 in a direction opposite to the second direction D2 and flows toward the first fan 210. At this time, the intake air flow AF cools the thermal shield plate 122 of the first heater unit 120. In other words, the first fan 210 generates an air flow that circulates through the magnetron 113 and the first heater unit 120 in this order.

In addition, when driven, the first fan 210 generates a blown air flow BF1, a blown air flow BF2, and a blown air flow BF3. The blown air flow BF1 is blown downward. The blown air flow BF1 circulates downward in the third space R3 between the air blower 140 and the rear outer wall 15. At this time, the blown air flow BF1 cools the drive unit 144 of the air blower 140.

A part of the blown air flow BF1 that has reached the lower outer wall 14 circulates inside the guide unit 700 in the second direction D2. The blown air flow BF1 circulating inside the guide unit 700 is discharged to the outside of the guide unit 700. The blown air flow BF1 discharged to the outside of the guide unit 700 cools the drive unit 71. The blown air flow BF1 that has cooled the drive unit 71 is discharged to the outside of the heating cooker 100.

In addition, the blown air flow BF2 reaches the first skew plate 501. The blown air flow BF2 reaching the first skew plate 501 is guided to the left wall 52 along the first skew plate 501. Further, the blown air flow BF3 reaches the second skew plate 503. The blown air flow BF3 reaching the second skew plate 503 is guided to the left wall 52 along the second skew plate 503.

As described above with reference to FIGS. 1 to 8, since the guide unit 700 guides the air flow from the first fan 210 to the drive unit 71, the drive unit 71 that drives the turntable 70 can be efficiently cooled even if the drive unit 71 is disposed on a leeward side of the second heater unit 130.

In addition, the guide unit 700 guides the air flow from the first fan 210 without passing through the second heater unit 130. As a result, the drive unit 71 can be cooled more efficiently. Further, since the suction port 702 is larger in size than the blow-out port 703, the drive unit 71 can be cooled more efficiently.

In addition, the remaining part of the blown air flow BF1 that has reached the lower outer wall 14 circulates outside the guide unit 700 in the second direction D2. At this time, the blown air flow BF1 cools the second heater case 132 of the second heater unit 130. The blown air flow BF1 that has cooled the second heater unit 130 is discharged to the outside of the heating cooker 100.

To be specific, a height position of an upper end portion of the suction port 702 is higher than a height position of a lower end portion 55a of the rear wall 55 of the heating cooking compartment 50. As a result, the blown air flow BF1 is curbed from circulating between an upper surface of the guide unit 700 and the second heater unit 130. Accordingly, the drive unit 71 can be cooled more efficiently.

In addition, a height position of an upper end portion of the blow-out port 703 is higher than a height position of an upper end portion of the drive unit 71. As a result, the air flow is curbed from circulating in a space between the upper surface of the guide unit 700 and the second heater unit 130, and the air flow from the blow-out port 703 entirely circulates to the drive unit 71 in a height direction, so that the drive unit 71 can be cooled more efficiently.

A width of the blow-out port 703 is larger than a width of the drive unit 71. As a result, the air flow from the blow-out port 703 entirely circulates to the drive unit 71 in a width direction, so that the drive unit 71 can be cooled more efficiently.

Further, by inclining a width of the guide unit 700 to become narrower from the suction port 702 toward the blow-out port 703, a pressure inside the guide unit 700 becomes higher than the pressure outside, so that it is possible to curb external air having a relatively high temperature from being suctioned through the plurality of openings 704.

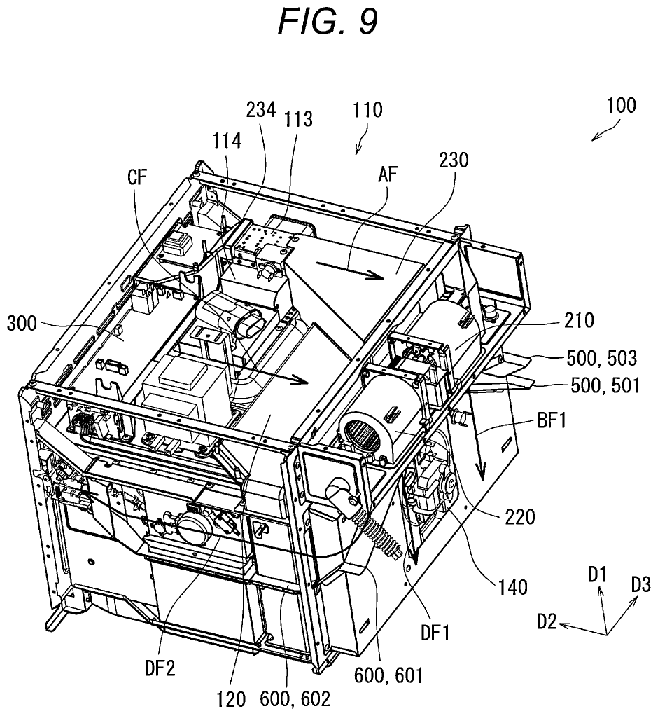

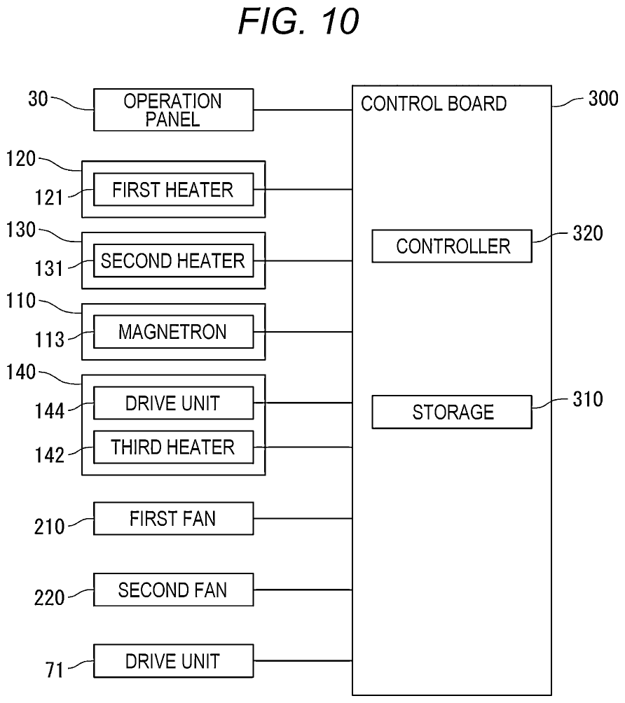

Continuing with reference to FIGS. 8 to 10, the second fan 220 will be described. FIG. 9 is a perspective view illustrating the heating cooker 100. To be specific, FIG. 9 illustrates the external appearance of the heating cooker 100 when viewed diagonally from the upper right rear. FIG. 10 is a block diagram illustrating a configuration of the heating cooker 100. As illustrated in FIGS. 8 to 10, the heating cooker 100 further includes the second fan 220, a second wind direction plate 600, and a control board 300.

The control board 300 includes a storage 310 and a controller 320. The storage 310 includes a random access memory (RAM) and a read only memory (ROM). The storage 310 stores control programs for controlling an operation of each component of the heating cooker 100.

The controller 320 is a hardware circuit including a processor such as a central processing unit (CPU). The controller 320 executes the control programs stored in the storage 310.

For example, the second fan 220 is a Sirocco fan. The first fan 210 and the second fan 220 are arranged side by side in the left-right direction. The second fan 220 is disposed on the upper wall 53 of the heating cooking compartment 50. In addition, the second fan 220 is disposed between the rear wall 55 of the heating cooking compartment 50 and the rear outer wall 15 of the housing 10. Specifically, the second fan 220 is disposed in the region in which the first space R1 and the third space R3 overlap each other.

To be specific, the second fan 220 is positioned at the same height as the plurality of through-hole portions 62 are. The second fan 220 generates an air flow between the upper wall 53 of the heating cooking compartment 50 and the upper outer wall 13 of the housing 10. The second fan 220 takes air outside the heating cooker 100 into the first space R1. In addition, the second fan 220 generates an air flow between the rear wall 55 of the heating cooking compartment 50 and the rear outer wall 15 of the housing 10. The second fan 220 discharges the air in the first space R1 into the third space R3.

The second wind direction plate 600 includes a skew plate 601. The skew plate 601 is disposed on the rear wall 55. The skew plate 601 is provided upright on the heat shield plate 146. The skew plate 601 extends from below the second fan 220 toward the right wall 51.

Here, a flow of air generated by driving of the second fan 220 will be described. When driven, the second fan 220 generates an intake air flow CF. The intake air flow CF passes through the plurality of through-hole portions 62 from the outside of the heating cooker 100, circulates in the first space R1 between the control board 300 and the upper outer wall 13 in the direction opposite to the second direction D2, and flows toward the first heater unit 120. At this time, the intake air flow CF cools the control board 300. The intake air flow CF that has cooled the control board 300 circulates in the first space R1 between the first heater unit 120 and the upper outer wall 13 in the direction opposite to the second direction D2 and flows toward the second fan 220. At this time, the intake air flow CF cools the thermal shield plate 122 of the first heater unit 120. In other words, the second fan 220 generates an air flow that circulates through the control board 300 and the first heater unit 120 in this order.

In addition, when driven, the second fan 220 generates a blown air flow DF1 and a blown air flow DF2. The blown air flow DF1 is blown downward. The blown air flow DF1 circulates downward in the third space R3 between the air blower 140 and the rear outer wall 15. At this time, the blown air flow DF1 cools the drive unit 144 of the air blower 140.

A part of the blown air flow DF1 that has reached the lower outer wall 14 circulates inside the guide unit 700 in the second direction D2. The blown air flow BF1 circulating inside the guide unit 700 is discharged to the outside of the guide unit 700. The blown air flow BF1 discharged to the outside of the guide unit 700 cools the drive unit 71. The blown air flow BF1 that has cooled the drive unit 71 is discharged to the outside of the heating cooker 100.

In addition, the remaining part of the blown air flow BF1 that has reached the lower outer wall 14 circulates outside the guide unit 700 in the second direction D2. At this time, the blown air flow BF1 cools the second heater case 132 of the second heater unit 130. The blown air flow BF1 that has cooled the second heater unit 130 is discharged to the outside of the heating cooker 100. As a result, since the guide unit 700 guides the air flow from the second fan 220 to the drive unit 71, the drive unit 71 that drives the turntable 70 can be efficiently cooled even if the drive unit 71 is disposed on a leeward side of the second heater unit 130.

In addition, the blown air flow DF2 reaches the skew plate 601. The blown air flow DF2 reaching the skew plate 601 is guided to the right wall 51 along the skew plate 601.

As illustrated in FIGS. 8 and 9 again, the heating cooker 100 further includes a front duct member 234 and a rear duct member 230.

The front duct member 234 extends from the front wall 60 toward the magnetron 113. Specifically, the front duct member 234 is a groove-shaped member having a substantially U-shaped cross section and a longitudinal direction in the second direction D2. The front duct member 234 is disposed in the first space R1. The front duct member 234 faces the upper wall 53.

To be specific, the front duct member 234 has a suction port 235 and a blow-out port 236. The suction port 235 is open in the second direction D2. The blow-out port 236 is open in the direction opposite to the second direction D2. The suction port 235 is smaller in size than the blow-out port 236. The blow-out port 236 is positioned in front of the magnetron 113. The blow-out port 236 is close to the magnetron 113.

The rear duct member 230 extends from the magnetron 113 toward the first fan 210.

Specifically, the rear duct member 230 is a groove-shaped member having a substantially U-shaped cross section and a longitudinal direction in the second direction D2. The rear duct member 230 is disposed in the first space R1. The rear duct member 230 faces the upper wall 53.

To be specific, the rear duct member 230 has a suction port 231 and a blow-out port 232. The suction port 231 is open in the second direction D2. The blow-out port 232 is open in the direction opposite to the second direction D2. The suction port 231 is smaller in size than the blow-out port 232. The blow-out port 232 is positioned in front of the first fan 210. The blow-out port 232 is close to the first fan 210.

Here, a flow of air generated by driving of the first fan 210 will be described. When driven, the first fan 210 generates an intake air flow AF. The intake air flow AF passes through the plurality of through-hole portions 62 from the outside of the heating cooker 100, circulates in the front duct member 234 in the direction opposite to second direction D2, and flows into rear duct member 230. At this time, the intake air flow AF cools the magnetron 113 of the microwave supply unit 110. The intake air flow AF that has cooled the magnetron 113 circulates in the rear duct member 230 in the direction opposite to the second direction D2 and flows toward the first fan 210. At this time, the intake air flow AF cools the thermal shield plate 122. In other words, the first fan 210 generates an air flow that circulates through the magnetron 113 and the first heater unit 120 in this order.

With reference to FIG. 10 again, a configuration of the heating cooker 100 will be described in detail. In the embodiment, the heating cooker 100 has, as heating cooking modes, a “microwave heating mode”, a “hot air circulation heating mode”, and a “grill heating mode”. The “microwave heating mode” is a mode for heating and cooking a heating-target object mainly by radiating microwaves into the heating cooking compartment 50. The “grill heating mode” means a mode for heating and cooking a heating-target object mainly by causing heat generated from the first heater unit 120 and the second heater unit 130 to radiate to the heating-target object. The “hot air circulation heating mode” is a mode for heating and cooking a heating-target object mainly by circulating hot air throughout the heating cooking compartment 50 to ensure a uniform temperature in the heating cooking compartment 50.

The controller 320 executes control programs stored in the storage 310, thereby controlling driving of the microwave supply unit 110, driving of the air blower 140, driving of the first heater unit 120, driving of the second heater unit 130, driving of the first fan 210, and driving of the second fan 220.

To be specific, the controller 320 controls the operation panel 30, the magnetron 113, the first heater 121, the second heater 131, the third heater 142, the drive unit 144, the drive unit 71, the first fan 210, and the second fan 220. For example, in the case where the “microwave heating mode” is selected, the controller 320 drives the magnetron 113, the first fan 210, and the second fan 220. In addition, in the case where the “grill heating mode” is selected, the controller 320 drives the first heater 121, the second heater 131, the drive unit 71, the first fan 210, and the second fan 220. Further, in the case where the “hot air circulation heating mode” is selected, the controller 320 drives the drive unit 144, the drive unit 71, the first fan 210, and the second fan 220, and drives at least one of the first heater 121, the second heater 131, and the third heater 142.

The embodiment of the present disclosure has been described above with reference to the drawings. However, the present disclosure is not limited to the above embodiment, and can be implemented in various aspects without departing from the gist thereof. For easy understanding, the drawings schematically illustrate the individual components mainly, and the thicknesses, lengths, number, and the like of the individual components illustrated in the drawings are different from actual ones for convenience of preparation of the drawings. In addition, the materials, shapes, dimensions, and the like of the individual components illustrated in the above embodiment are merely examples, and are not particularly limited, and various modifications can be made without substantially departing from the effects of the present disclosure.

The present disclosure provides a heating cooker, and has industrial applicability.

What is claimed is:

1. A heating cooker comprising:
a heating cooking compartment having an opening;
a door configured to open and close the opening;
a heater unit disposed below the heating cooking compartment;
a turntable disposed inside the heating cooking compartment and configured to allow a heating-target object to be placed on the turntable;
a drive unit disposed below the heating cooking compartment and configured to drive the turntable;
a fan configured to generate an air flow; and
a guide unit configured to guide the air flow,
wherein
the drive unit is disposed closer to the door than the heater unit, and
the guide unit guides the air flow to the drive unit.

2. The heating cooker according to claim 1, wherein the guide unit guides the air flow without passing through the heater unit.

3. The heating cooker according to claim 2, further comprising a housing configured to accommodate the heating cooking compartment,
wherein a lower outer wall of the housing and the guide unit guide the air flow to the drive unit.

4. The heating cooker according to claim 3, wherein
the guide unit has a suction port and a blow-out port, and
a height position of an upper end portion of the suction port is higher than a height position of a lower end portion of a rear wall of the heating cooking compartment.

5. The heating cooker according to claim 4, wherein a size of the suction port is larger than a size of the blow-out port.

6. The heating cooker according to claim 5, wherein
the guide unit includes a groove-shaped body extending in a front-rear direction, and
a side surface of the groove-shaped body is provided such that the blow-out port is narrower than the suction port.

7. The heating cooker according to claim 6. wherein the groove-shaped body has a plurality of openings.
